(19) United States
(12) Patent Application Publication
(10) Pub. No.: US 2025/0028761 A1
(43) Pub. Date: Jan. 23, 2025

(54) DATA TRACKING ON A COMPUTING DEVICE USING A DISTRIBUTED LEDGER

(71) Applicant: VMware LLC, Palo Alto, CA (US)

(72) Inventors: Daniel Beveridge, Valrico, FL (US); Sean James Huntley, Sydney (AU); David Ott, Chandler, AZ (US)

(21) Appl. No.: 18/355,079

(22) Filed: Jul. 19, 2023

(51) Int. Cl. G06F 16/907

(52) U.S. Cl. CPC G06F 16/907

(57) ABSTRACT

Disclosed are examples of a system that publishes metadata to a blockchain network. The metadata can contain properties of data generated by a system. The metadata can allow for other entities to validate or trust the data generated by the system. The metadata can include data attributes that profile the data.

### CROSS-REFERENCE TO RELATED APPLICATIONS

This application is related in subject matter to U.S. application Ser. Nos. 18/354,351, 18/094,431, and 18/101,616, the contents of which are incorporated herein by reference in their entireties.

### BACKGROUND

Configurations for devices are often managed by management services, such as unified endpoint management (UEM) services. These management services can be used to ensure that client devices remain in compliance with various rules or policies. For example, a management service could enforce a specific device configuration or application configuration settings to ensure compliance. Moreover, updated configuration settings can be provided to client devices as changes to compliance rules or policies are made, and the changes could be enforced by the management service.

Additionally, the usage of applications, services, processors, or other hardware and software on the client device might be tracked in order to determine how much a particular application or hardware component is utilized. Usage statistics can be utilized for various purposes, such as for performance monitoring, billing of services, and for other purposes. In addition to the usage of applications on a device, the data generated by applications and stored on the client device and elsewhere might also be tracked for the same or similar purposes. However, in some environments, the device or system generating the data must be absolutely trusted in order to trust that the data stored on the device has not been tampered with.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1A is a drawing of a network environment according to various embodiments of the present disclosure.

FIG. 1B is a drawing of a network environment according to various embodiments of the present disclosure.

FIG. 2 is a sequence diagram illustrating one example of functionality implemented as portions of an application executed in a computing environment in the network environment of FIG. 1 according to various embodiments of the present disclosure.

FIG. 3 is a sequence diagram illustrating one example of functionality implemented as portions of an application executed in a computing environment in the network environment of FIG. 1 according to various embodiments of the present disclosure.

### DETAILED DESCRIPTION

The present disclosure relates to determining and tracking the data generated by a computing system or device utilizing an immutable and non-reputable data store, such as a blockchain hosted by a blockchain network. Current distributed network architectures and distributed or cloud-based deployment of many computing services makes trusting the data generated by applications running on devices difficult. For example, an enterprise can have computing devices or environments that are distributed or virtualized. Data can be generated by these devices and provided to other devices or parties for various purposes. However, trusting the validity of the data requires trusting the system or device that generated the data.

In examples of this disclosure, multiple blockchains can be utilized to enforce a particular configuration state on a device so that the device, its configuration, and the applications running on the device can be trusted and attested to by data stored on a distributed ledger. Another blockchain can be utilized to publish or aggregate information about the usage of a device so that multiple parties can access this usage information. Another blockchain can be utilized to publish or aggregate information about the data generated by applications running on the device so that data generated by these applications can be trusted by other parties with which the device is potentially communicating. The blockchain on which information about usage is published can be public and accessed by various parties to facilitate auditing, billing, or other purposes for which usage information is desired to be public. Similarly, the blockchain on which information about data generated by the device can also be public and accessed by other parties to facilitate auditing or assessment of the data generated by the device. However, a private blockchain can be utilized to house private information about the device, such as the particular configuration of the device. A public blockchains utilized for usage or data integrity purposes can also be a permissioned blockchain that is accessible by third parties utilizing one or more credentials.

Configuration states that specify rules constraints for devices or applications can be set by an administrator using a management service. The configuration state might specify how a device should be configured, which applications or services should be executed on the device, or the configuration of containers that can be running on a managed device. For example, the configuration state can specify that the computing device can only utilize data storage that is located in particular locations, such as particular countries or other types of jurisdictions in compliance with data sovereignty laws or regulations. The management service can then publish the configuration state to a configuration blockchain.

Subsequently, a management agent executing on a client device can query a configuration blockchain to obtain the configuration of the device to determine which applications should be executed on the device and the configuration of the applications. In some cases, before performing an operation such as the execution of an application or operating system feature, a management sovereignty agent on a client device can query the blockchain to obtain permitted operations specified for the client device by the management service.

A management agent or a client application installed on a client device can perform an operation, such as execution of an application or invoking an operating system feature, such as network access, data storage operations, data retrieval operations, GPU operations, or any other hardware or software feature that can be gated behind an operating system, if the requested operation is permitted by a configuration state corresponding to the client device that is published the configuration blockchain. For example, a requested data storage technique can encompass libraries, algorithms, configuration values, and/or the like to select based on factors such as the type of data being generated or handled, a user account associated with the data operation, the network environment(s) in which the data is to be sent or retrieved from, a destination to which data is to be sent, geographic locations associated with a source and/or destination of the data, attributes of users associated with the data, regulatory environments related to the data, network conditions, resource availability, performance constraints, device capabilities, and/or the like.

A management service can allow users (e.g., administrators) to define policies, rules, and/or configurations. A configuration can specify rules for configuring a client device and the permitted applications and operations that can be utilized by the applications on the device. A configuration can allow the administrator to specify rules that a rules engine on the client device can utilize to determine whether a requested operation is permitted based upon the parameters associated with the request. The administrator, using the management service, can update the policies by pushing a new or updated configuration to the configuration blockchain.

In some examples, deploying a policy via a configuration on the blockchain can utilize multi-signature frameworks that can be enforced using a blockchain network. In this scenario, a change or an update to the configuration state of a system can require multiple users to approve the change. Accordingly, examples of the disclosure can utilize multisig frameworks that are available using blockchain networks to require multiple parties to sign off on a transaction. In this case, the transaction would constitute the publishing or the approval of a new configuration state corresponding to the configuration of a computing device.

In examples of the disclosure, a second blockchain, which can be referred to herein as a business substrate blockchain, can be utilized to store information about the usage of a client device that is configured utilizing a configuration blockchain. While the configuration blockchain can be private such that it is only accessible to the management service and devices that are managed by the management service, the business substrate blockchain can be public or permissioned so that third parties can access the data stored on the business substrate blockchain. A smart contract residing on the business substrate blockchain can be executed by a management agent of a client device that can result in usage data or data related to events occurring on the client device to be published on the business substrate blockchain. This usage data can be utilized by third parties for auditing, analytics, billing, or other purposes for which usage data can be obtained.

A third blockchain, referred to herein as a data attribute blockchain, can be utilized to store metadata relating to data generated by applications running on a computing device. The metadata can be trusted because the configuration of the computing device can be trusted due to the configuration blockchain that is utilized to specify the configuration of the device. The metadata can be tightly coupled to the data generated by the computing device so that other parties can trust the validity or accuracy of the data that is generated by the computing device. In some examples, the metadata can comprise a hash of the data, a rollup of the data, or other representations of the data. In some cases, the metadata or components within the metadata can be signed. In certain examples, an encrypted wrapper or shield that is stored on the data attribute blockchain can comprise the metadata and/or a hash for the metadata. The data attribute blockchain enables entities or parties to prove that they are observant of data policies, regulations, laws, or other requirements or recommendations with respect to handling of data that is generated on a computing device.

In the following discussion, a general description of the system and its components is provided, followed by a discussion of the operation of the same. Although the following discussion provides illustrative examples of the operation of various components of the present disclosure, the use of the following illustrative examples does not exclude other implementations that are consistent with the principals disclosed by the following illustrative examples.

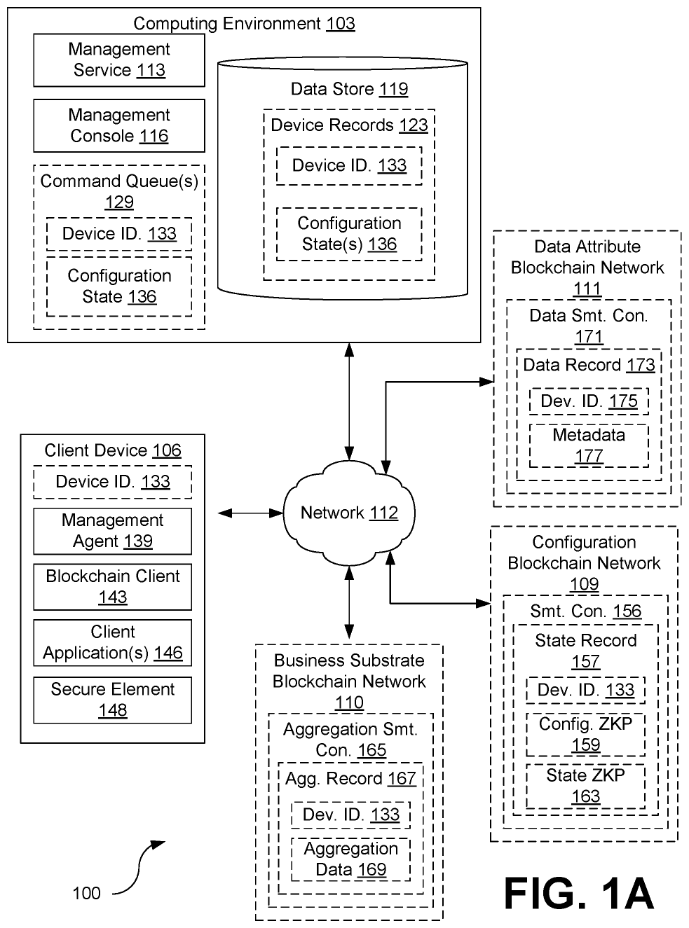

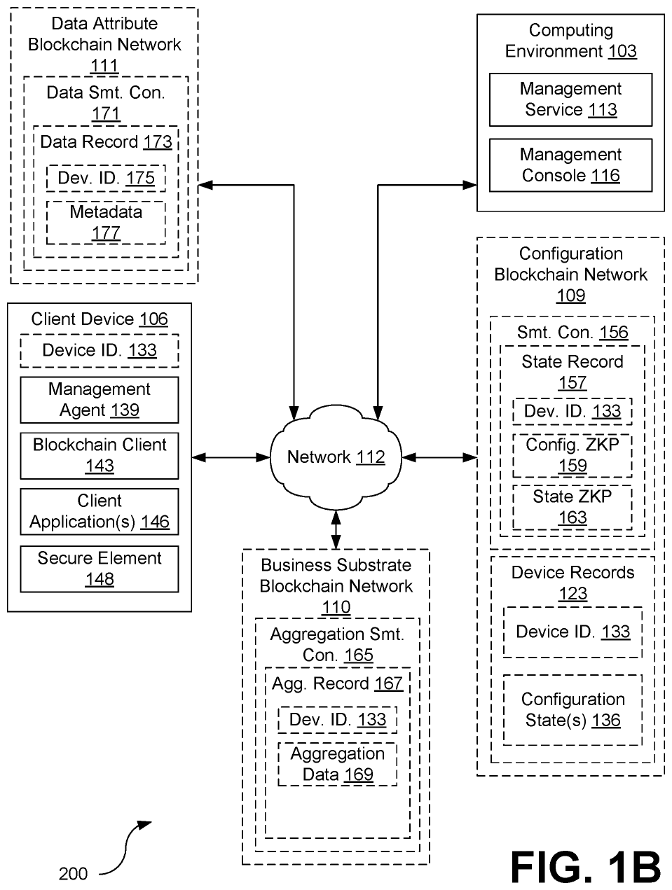

With reference to FIG. 1, shown is a network environment 100 according to various embodiments. The network environment 100 can include a computing environment 103, a client device 106, a configuration blockchain network 109, a business substrate blockchain network 110, and a data attribute blockchain network 111, which can be in data communication with each other via a network 112. Although depicted separately for illustrative purposes, individual computing devices or software applications within the computing environment 103 could also be members of or participate in the configuration blockchain network 109. Likewise, while depicted separately for illustrative purposes, the client device 106 could also be a member of or participate in the configuration blockchain network 109.

The network 112 can include wide area networks (WANs), local area networks (LANs), personal area networks (PANs), or a combination thereof. These networks can include wired or wireless components or a combination thereof. Wired networks can include Ethernet networks, cable networks, fiber optic networks, and telephone networks such as dial-up, digital subscriber line (DSL), and integrated services digital network (ISDN) networks. Wireless networks can include cellular networks, satellite networks, Institute of Electrical and Electronic Engineers (IEEE) 802.11 wireless networks (e.g., WI-FIR), BLUETOOTH® networks, microwave transmission networks, as well as other networks relying on radio broadcasts. The network 112 can also include a combination of two or more networks 112. Examples of networks 112 can include the Internet, intranets, extranets, virtual private networks (VPNs), and similar networks.

The computing environment 103 can include one or more computing devices that include a processor, a memory, and/or a network interface. For example, the computing devices can be configured to perform computations on behalf of other computing devices or applications. As another example, such computing devices can host and/or provide content to other computing devices in response to requests for content.

Moreover, the computing environment 103 can employ a plurality of computing devices that can be arranged in one or more server banks or computer banks or other arrangements. Such computing devices can be in a single installation or can be distributed among many different geographical locations. For example, the computing environment 103 can include a plurality of computing devices that together can include a hosted computing resource, a grid computing resource or any other distributed computing arrangement. In some cases, the computing environment 103 can correspond to an elastic computing resource where the allotted capacity of processing, network, storage, or other computing-related resources can vary over time.

Various applications or other functionality can be executed in the computing environment 103. The components executed on the computing environment 103 can include a management service 113, a management console 116, as well as other applications, services, processes, systems, engines, or functionality. Although the management service 113 and the management console 116 are depicted separately for illustrative purposes, some or all of these applications could be combined into a single application that implements the functionality of the combined applications. Moreover, one or more of these applications could be executed on the same computing device within the computing environment 103 or on one or more separate computing devices within the computing environment 103.

Also, various data is stored in a data store 119 that is accessible to the computing environment 103. The data store 119 can be representative of a plurality of data stores 119, which can include relational databases or non-relational databases such as object-oriented databases, hierarchical databases, hash tables or similar key-value data stores, as well as other data storage applications or data structures. Moreover, combinations of these databases, data storage applications, and/or data structures may be used together to provide a single, logical, data store. The data stored in the data store 119 is associated with the operation of the various applications or functional entities described below. This data can include one or more device records 123 as well as potentially other data.

In addition to the data stored in the data store 119, the computing environment 103 could also maintain one or more command queues 129. In some implementations, the command queues 129 could be maintained or stored in a separate data structure or location, as illustrated. In other implementations, however, the command queues 129 could be stored in the data store 119 along with the device records 123.

A device record 123 can be used to store any information related to a client device 106 enrolled with or managed by the management service 113. This can include any information about the current or last known state of the client device 106, such as applications installed on the client device or the last reported state of the client device 106. This can also include information about the user who is currently using the client device 106. Accordingly, the device record 123 can include information such as a device identifier 133, and one or more configuration states 136. A device record 123 can also be stored on the configuration blockchain network 109 in some implementations.

The device identifier 133 can include any identifier that uniquely identifies one client device 106 with respect to another client device 106. Examples of device identifiers 133 include device names, globally unique identifiers (GUIDs), universally unique identifiers (UUIDs), network interface media access controller (MAC) addresses, international mobile equipment identity (IMEI) numbers, etc.

A configuration state 136 can represent any current or past configuration of the client device 106. The configuration state 136 can include values to be used for operating system settings for the client device 106 or for settings for individual applications installed on the client device 106. Text or markup language files (e.g., extensible markup language (XML) or yet another markup language (YAML) files) could be used to store a configuration state 136. The current configuration state 136 can be stored in a command queue 129 to be retrieved by the client device 106. The management service 113 can also publish the current configuration state 136 to the configuration blockchain network 109 for retrieval by client devices 106.

The configuration state 136 can identify the applications that a particular client device 106 is permitted to execute. A configuration state 136 can also specify data operations that the client device 106 is permitted to utilize. The configuration state 136 can also specify operating system profiles, settings, and policies for a client device 106. For example, an application running on a client device 106 can submit a request to perform a data operation (e.g., via a call to an abstracted data storage or retrieval API), and a management agent 139 running on the client device 106 can determine whether the request complies with configuration state 136 before performing the requested data operation. The requested data operation can involve the execution of an application or container on the client device 106. The requested data operation can also involve storage, processing, or transmitting data via a data storage or retrieval API call that calls a library that consults whether the request complies with a configuration state 136 for the client device 106. The requested data operation can further include changing the configuration state of a client device 106 that is managed according to examples of the disclosure.

As another example, the configuration state 136 can specify an application or container that is permitted to be running on the client device 106. The configuration state 136 can further identify certain hardware resources of the client device 106 that an application is permitted to use, such as networking, storage, GPU, or other resources. The configuration state 136 can also specify that applications should be executed in coordination with a secure element 148 of the client device 106 consistent with confidential computing principles.

A secure element 148, secure enclave device, or secure chipset, such as a trusted platform module (TPM), of a client device 106 can also attest the execution of the applications or containers on a client device 106 to the configuration blockchain network 109 and/or the business substrate blockchain network 110. For example, the secure element of the client device 106 can write piece of data that is signed or attested by the secure element on the client device 106. In one example, a private key assigned to the client device 106 and available to the secure element can be utilized to sign the data. The signed data can then be written to the configuration blockchain network 109 or business substrate blockchain network 110, such as in the form of an attestation zero knowledge proof or an attestation data element that can be utilized to verify that the client device 106 is running in an approved configuration state. In another example, client device 106 may contain a secure enclave system element such as Intel SGX (Software Guard Extensions) for isolated execution of sensitive code, this code being attested for execution by comparison of its checksum or cryptographic hash (e.g., a trusted computing measurement) to an approved workload checksum stored on the blockchain, ensuring the integrity of the code executing on the client device 106. An attestation data element can be written to the configuration blockchain network 109 or business substrate blockchain network 110 to attest the execution or configuration of a particular virtual machine, data structure, or application on a client device 106.

The management service 113 can manage the configuration of registered or enrolled client devices 106. This can include distributing a configuration state 136 to client devices 106 via the configuration blockchain network 109. The management service 113 can also provide various facilities or mechanisms to determine or otherwise ensure that enrolled client devices 106 are compliant with an applicable configuration state 136 that is specified by the client device 106.

The management console 116 can represent any user interface or user front-end to the management service 113. In some implementations, the management console 116 could be executed as a separate, independent service that interacts with the management service 113. In other implementations, the management console 116 could be a component of the management service 113. The management console 116 can represent any user interface or user front-end that allows an administrator or other user to manage, review, or analyze client devices 106 that are enrolled with the management service 113. The management console 116 could be accessible using a client device 106 over the network 112.

The client device 106 is representative of a plurality of client devices that can be coupled to the network 112. This could include physical devices embodied in the form of a personal computer (e.g., a desktop computer, a laptop computer, or similar device), a mobile computing device (e.g., personal digital assistants, cellular telephones, smartphones, web pads, tablet computer systems, music players, portable game consoles, electronic book readers, and similar devices), or other devices with like capability. This could also include virtual or logical devices, such as virtual machines, containers, etc.

The client device 106 can be configured to execute various applications such as a management agent 139, a blockchain client 143, and client applications 146.

The management agent 139 can locally manage the client device 106 to enforce configuration settings specified by the management service 116 in the configuration state 136. The management agent 139 can be installed with elevated privileges or be effectuated through operating system APIs to manage the client device 106 on behalf of the management service 113. The management agent 139 can have the authority to manage data on the client device 106, install, remove, or disable certain applications, control the reading or writing of data, control the communication of data with external or remotely located systems, or install configuration profiles, such as VPN certificates, Wi-Fi profiles, email profiles, etc. The management agent 139 can also have the authority to enable or disable certain hardware features of the client device 106 that as specified in the configuration state 136 for the client device 106. The management agent 139 can also place the device into different hardware modes, such as airplane mode, silent mode, do-not-disturb mode, or other modes supported by the client device 106.

The management agent 139 can control execution of applications or containers on the client device 106 by enforcing one or more policies specified by a configuration state 136 that specifies which application or containers, or the configurations of applications or containers, that are permitted to be executed on the client device 106. The configuration state 136 can be obtained from the configuration blockchain network 109 by the management agent 139.

The blockchain client 143 can represent any type of software application or library that allows for the client device 106 to connect and interact with the configuration blockchain network 109. Examples of blockchain clients 143 include full blockchain nodes, light blockchain clients, and stateless blockchain clients. In some implementations, the blockchain client 143 and the management agent 139 may be tightly coupled, whereby the management agent 139 is required to use the blockchain client 143 to perform various operations. In some of these implementations, the management agent 139 and the blockchain client 143 could be deployed as a single instance of an application.

A client application 146 can run on a client device 106 and generate data for various purposes. For example, client application 146 can represent an application that processes inputs and generates a data output that is stored on the client device 106. The data output can be provided to consumers of the data that may use the data for various purposes. For example, a user of a service provided by the client application 146 might request that an operation be run on an input and utilize the output of the operation. The client application 146 can be a hosted service that can create data outputs for data consumers. The client application 146 can represent a software-as-a-service (SaaS) or any application that can be executed by or on behalf of an enterprise.

The configuration blockchain network 109, data attribute blockchain network 111 and/or business substrate blockchain network 110 represents a peer-to-peer network of nodes 149 that utilizes a consensus protocol to maintain an immutable, append only, eventually consistent data store such as a blockchain 153. In some implementations, the configuration blockchain network 109, data attribute blockchain network 111, and/or business substrate blockchain network 110 could be a permissioned blockchain network, where only authorized nodes are permitted to join or participate in the blockchain network. Examples of permissioned blockchain networks include HYPERLEDGER FABRIC, QUOROM, VMWARE BLOCKCHAIN, and CORDA. In other implementations, the configuration blockchain network 109 could be permissionless, where anyone is permitted to join the configuration blockchain network 109. Examples of public or permissionless blockchain networks 109 include the BITCOIN network, the ETHEREUM network, the SOLANA network, etc.

Nodes of the configuration blockchain network 109, data attribute blockchain network 111, or business substrate blockchain network 110 can represent computing devices and/or virtual machines that maintain a copy of the blockchain data and all transactions submitted to the configuration blockchain network 109, data attribute blockchain network 111, or business substrate blockchain network 110 for inclusion in a respective blockchain. In some blockchain networks, individual nodes can perform specialized functions, such as creating or validating new blocks for the blockchain (sometimes referred to as “mining”), storing a copy of the current state of the blockchain, responding to requests for the current state of the blockchain, etc. In other blockchain networks, one or more of these functions to be performed by the same node.

A respective blockchain on the configuration blockchain network 109, data attribute blockchain network 111, or business substrate blockchain network 110 can represent an immutable, append only, eventually consistent distributed data store maintained by a plurality of nodes in a peer-to-peer network that maintain duplicate copies of data stored in the blockchain. The nodes of the configuration blockchain network 109, data attribute blockchain network 111, or business substrate blockchain network 110 can use a variety of consensus protocols to coordinate the writing of data written to the blockchain. In order to store data to the blockchain, such as a record of a transaction of cryptocurrency coins or tokens between wallet addresses, users can pay cryptocurrency coins or tokens to one or more of the nodes of the blockchain.

New data is written to the blockchain in the form of blocks, with each block including the cryptographic hash of the previous block in the blockchain, thereby preventing tampering or altering of records stored in the blockchain. For example, whenever a new configuration state 136 is saved to a device record 123 by the management service 113, the management service 113 could save the new configuration state 136 to a new block in the blockchain. The management service 113 could also store the device identifier 133 of each client device 106 that the new configuration state 136 is applicable to. In some implementations, a cryptographic hash or other zero-knowledge proof of the configuration state 136 could be saved to the blockchain 153.

Whenever usage data relating to an event occurring on a client device 106 is saved to the business substrate blockchain network 110, the management agent 139 or a smart contract on the business substrate blockchain network 110 can save the event data to a new block on the blockchain of the business substrate blockchain network 110.

In some implementations, a configuration smart contract 156 or an aggregation smart contract 165 can be hosted on configuration blockchain network 109 or business substrate blockchain network 110, respectively. A smart contract can represent executable computer code that can be executed by a node of the configuration blockchain network 109 or business substrate blockchain network 110. In many implementations, the configuration smart contract 156 or aggregation smart contract 165 can expose one or more functions that can be called by any user or by a limited set of users. To execute one or more functions of a configuration smart contract 156 or aggregation smart contract 165, an application can submit a request to a node of the configuration blockchain network 109 or business substrate blockchain network 110 to execute the function. Similarly, an aggregation smart contract 165 can expose one or more functions that can be called by any user or by a limited set of users. To execute one or more functions of an aggregation smart contract 165, an application can submit a request to a node of the business substrate blockchain network 110 to execute the function. The node can then execute the function and store the result to the blockchain on one of the configuration blockchain network 109 or business substrate blockchain network 110.

Similarly, a data smart contract 171 can be hosted on the data attribute blockchain network 111. A data smart contract 171 can represent executable computer code that can be executed by a node of the data attribute blockchain network 111. The data smart contract 171 can expose one or more functions that can be called by any user or by a limited set of users. An application can submit a request to a node of the data attribute blockchain network 111 to execute the functionality of the data smart contract 171. The node can then execute the function and store the result to the blockchain on the data smart contract 171.

Nodes may charge fees in the form of cryptocurrency coins or tokens to execute a function and store the output, with more complicated or extensive functions requiring larger fees. An example of this implementation is the ETHEREUM blockchain network, where users can pay fees, referred to as “gas,” in order to have a node of the ETHEREUM blockchain network execute the function and store the result to the ETHEREUM blockchain. Additionally, the more “gas” a user pays, the more quickly the function will be executed, and its results committed to the ETHEREUM blockchain.

The configuration smart contract 156 can be used to store and maintain data on the blockchain related to the operation of the management service 113 and the management agent 139. For example, the configuration smart contract 156 could maintain one or more state records 157, which could be stored on the blockchain 153. Each state record 157 could represent the current configuration state 136 for a client device 106. However, because the blockchain 153 may be publicly accessible, it could be undesirable to store the current configuration state 136 itself on the blockchain 153. Accordingly, a state record 157 could include a device identifier 133 for a specific client device 106 and a state zero-knowledge proof (ZKP) 159 that represents the current state of the client device 106. The management agent 139 could generate the state ZKP 163 and submit it to the configuration smart contract 156 to store on the blockchain 153 to prove that the current state of the client device 106 complies with the current configuration state 136 assigned by the management service 113 without explicitly disclosing the current configuration of the client device 106. The management service 113 or other applications (e.g., such as those run by auditors) could evaluate the state ZKP 163 to confirm that state the client device 106 matches the configuration state 136 specified for the client device 106. Examples of ZKPs that could be used for the state ZKP 163 can include non-interactive zero knowledge (NIZK) proofs, zero-knowledge succinct non-interactive argument of knowledge (zk-SNARK) proofs, and zero-knowledge scalable transparent argument of knowledge (zk-STARK) proofs.

A configuration state 136 can specify which applications or services are permitted to be executed on a client device 106 by sending a configuration policy for the client device 106 that is enforced by the management agent 139 on the device. The configuration state 136 can also specify one or more certificates or keys that are to be distributed to the client device 106 by the management service 113. For example, the configuration state 136 can specify a particular key pair that can be distributed to the client device 106 and utilized by the client application 146 or other applications to sign information that is distributed to the business substrate blockchain network 110 or data attribute blockchain network 111. By signing data provided to the business substrate blockchain network 110 or data attribute blockchain network 111, other entities can validate that the information published to the business substrate blockchain network 110 or data attribute blockchain network 111 originated from the client device 106. Additionally, because the client device 106 is managed by a management agent 139 that applies a configuration state 136 provided by the management service 113, the execution environment in which a client application 146 operates can be trusted as well.

An aggregation smart contract 165 can be used to store and maintain data on the blockchain related to the operation of the client device 106. The data stored on the business substrate blockchain network 110 can be related to events occurring on the client device 106, such as usage data corresponding to applications or hardware resources of the client device 106. For example, the aggregation smart contract 165 could maintain aggregation records 167, which could be stored on the blockchain. The aggregation records 167 could represent data relating to usage on the client device 106. Because the business substrate blockchain network 110 may be publicly accessible, an aggregation records 167 can be publicly accessible. Accordingly, an aggregation records 167 could include a device identifier 133 for a specific client device 106 and aggregation data 169 that represents the data related to an event occurring on the client device 106. The event can relate an application executing on the client device 106, such as usage information of the application or hardware resources utilized by the application.

In some cases, an audit smart contract can run on the business substrate blockchain network 110 to generate audit data, analytics, or otherwise utilize the aggregation records 167 that are stored to the business substrate blockchain network 110. The audit smart contract can determine the usage of software or hardware resources of a client device 106 with which the aggregation records 167 are linked.

A data smart contract 171 can be used to store data on the blockchain related to data that is generated by a client application 146 running on a client device 106. The data stored on the data attribute blockchain network 111 can be related to events occurring on the client device 106, such as the output of data operations that are performed by a client application 146 running on the client device 106. For example, the data smart contract 171 can obtain metadata 177 that is associated with data generated by a client application 146, which could be stored on the blockchain. The metadata 177 could represent metadata characterizing data generated by relating to usage on the client device 106. Because the data attribute blockchain network 111 may be publicly accessible, a data record 173 stored on the data attribute blockchain network 111 can be publicly accessible. Accordingly, a data record 173 could include a device identifier 133 for a specific client device 106 and metadata 177 that is related to represents the data related to an event occurring on the client device 106. The event can relate an application executing on the client device 106, such as a data output generated by an application on the client device 106. The data smart contract 171 can also audit the data published to the data attribute blockchain network 111 and publish an audit result to the data attribute blockchain network 111.

The data record 173 can include a data profile of data generated on the client device 106. A data profile can comprise a classification of the data, such as a data type, a data owner, a data format, a licensing arrangement associated with the data, and one or more location attributes associated with the data.

In some implementations, the data record 173 can comprise a rollup of the data generated by a client application 146 running on the client device 106. The metadata 177 can further include a hash of the data generated by the client application 146 so that a consumer of the data, such as another computing device, can verify the validity of the data received from the client device 106 by comparing the data with the hash of the data that is included in the data record 173. In some examples, the hash of the data can be signed by a private key issued to the client device 106 that is specified by the configuration state 136 applied to the client device 106 by the management agent 139. The hash of the data, a data classification, and/or a rollup of the data can be stored in the data record 173 by the management agent 139 or the blockchain client 143, which can cause a data smart contract 171 running on the data attribute blockchain network 111 to receive the metadata 177 and store the metadata 177 in a data record 173 on the data attribute blockchain network 111. The metadata 177 can be stored in a data record 173 along with a device identifier 175 that uniquely identifies the client device 106.

In some cases, the data record 173 can comprise a ZKP that includes a representation of the data record 173 without including certain sensitive information from the client device 106 or the application itself. Other applications (e.g., such as those run by third parties or other systems) could evaluate the metadata 177 within the data record 173 to evaluate or generate data received from the computing environment 103 independently. In some examples, the data can be embedded within the data record 173 and retrieved from the data attribute blockchain network 111 by the other system or entity. Examples of ZKPs that could be used for the data record 173 can include non-interactive zero knowledge (NIZK) proofs, zero-knowledge succinct non-interactive argument of knowledge (zk-SNARK) proofs, and zero-knowledge scalable transparent argument of knowledge (zk-STARK) proofs.

FIG. 1B depicts a network environment 200 according to various embodiments. The network environment 200 can include a computing environment 103, a client device 106, a configuration blockchain network 109, a business substrate blockchain network 110, and a data attribute blockchain network 111 which can be in data communication with each other via a network 112. Although depicted separately for illustrative purposes, individual computing devices or software applications within the computing environment 103 could also be members of or participate in the configuration blockchain network 109. Likewise, while depicted separately for illustrative purposes, the client device 106 could also be a member of or participate in the configuration blockchain network 109.

The network environment 200 has many of the same components as the network environment 100. For example, the computing environment 103 can execute a management service 113 and a management console 116, as previously described. Moreover, the computing environment 103 can optionally host a data store. Likewise, each client device 106 can store a device identifier 133 and can also host or otherwise execute a management agent 139, blockchain client 143, and/or client application 146. Likewise, the configuration blockchain network 109, business substrate blockchain network 110, and data attribute blockchain network 111 can be formed from one or more nodes that host a blockchain. The blockchain of the configuration blockchain network 109 can store various data or executable programs, such as the configuration smart contract 156. Unlike the network environment 100 of FIG. 1A, the configuration smart contract 156 of the blockchain can also store one or more of the device records 123, which can include the device identifier 133 for each device record 123 as well as one or more configuration states 136.

In implementations such as those depicted in the network environment 200 of FIG. 1B, the configuration state 136 of a client device 106 is tightly coupled to the blockchain, providing for verifiability, auditability, and non-reputability. The management service 113 can create and store device records 123 on the blockchain by interacting with the configuration smart contract 156. When a new configuration state 136 is created for a device record 123, the new configuration state 136 can be saved to the appropriate device record 123 in the data store 119. Subsequently, the management service 113 can publish the new configuration state 136 to the blockchain by interacting with the configuration smart contract 156. The blockchain client 143 can later retrieve the current or latest configuration state 136 from the device record 123 stored by the configuration smart contract 156, and the configuration state 136 can be applied to the client device 106 by the management agent 139.

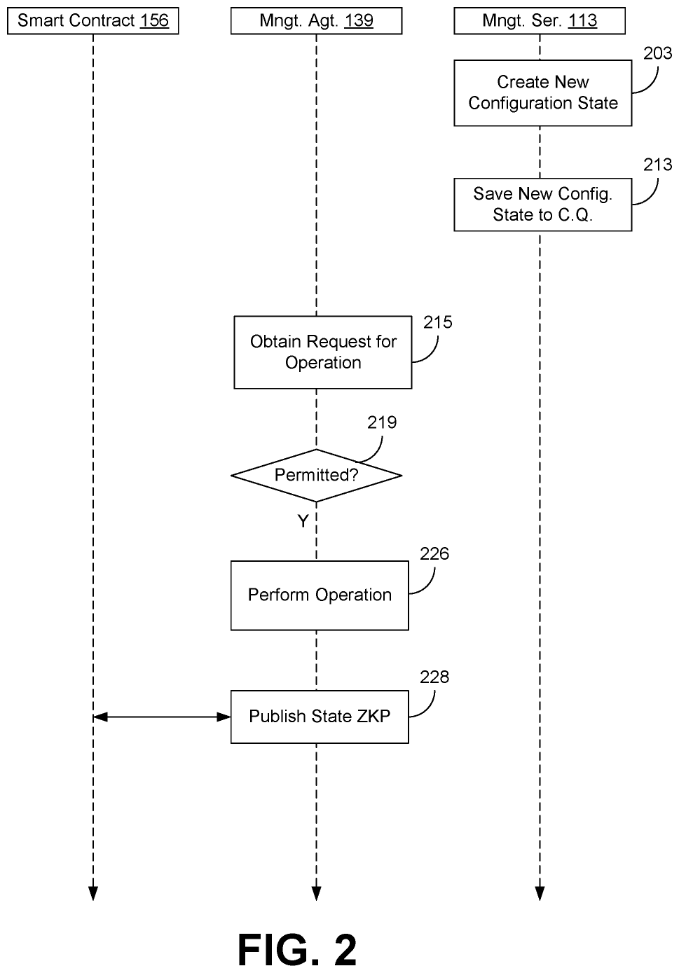

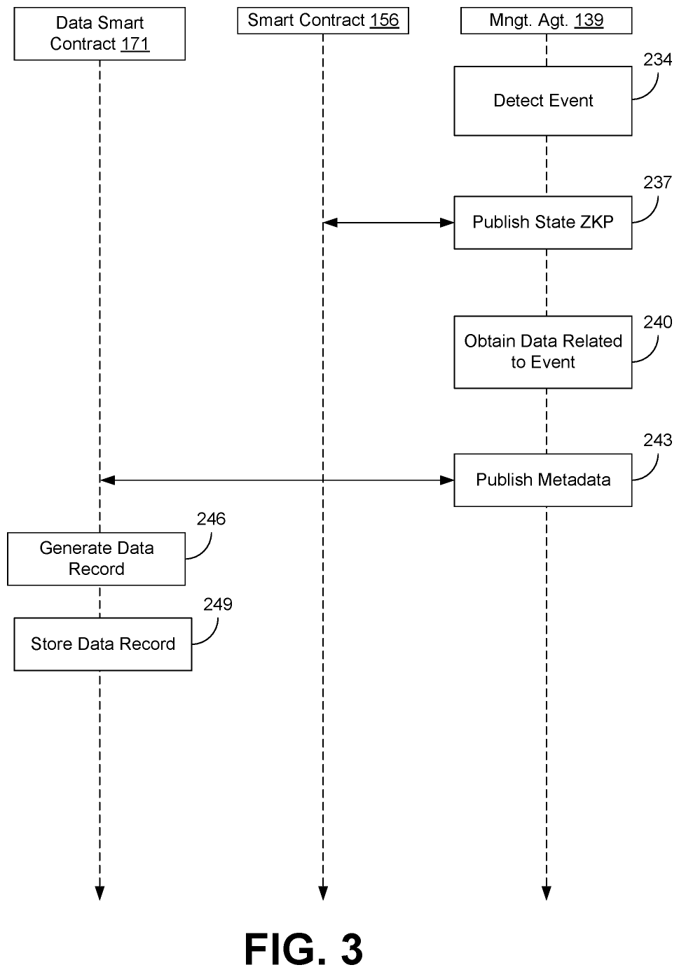

Next, a general description of the operation of the various components of the network environment 100 is provided. Although the following description provides an example of the operation of the network environment 100, other interactions between the various components of the network environment 100 are also included within the scope of the various embodiments of the present disclosure. More detailed descriptions of the operations of specific components of the network environment 100 are provided in the discussion accompanying FIGS. 2 and 3.

To begin, the management service 113 can enroll one or more client devices 106 for mobile device management or unified endpoint management (UEM) services. In some implementations, the management service 113 can manage devices that are deployed in as nodes in a distributed system that provides computing resources to enterprises or developers, such as in a software defined data center or another type of enterprise environment. In any scenario, the management service 113 can identify and authenticate one of the client devices 106 and store data related to the client device 106 in a device record 123 for later reference. In some cases, the management service 113 can also be registered as a device administrator of the client device 106, permitting the management service 113 to configure and manage certain operating aspects of the client device 106. In other cases, the operating system of the client device 106 can be configured to obtain a configuration state 136 from the configuration blockchain network 109 regarding data storage operations that are requested by applications on the client device 106.

In one embodiment, once a client device 106 is enrolled for device management by the management service 113, the management service 113 can create an individual command queue 129 for the client device 106 and/or assign the client device 106 to one or more group command queues 129. An individual command queue 129 could be maintained for client device 106 specific commands or configurations. Group command queues 129 could be maintained for commands or configurations that are applicable to groups of client devices 106 (e.g., all client devices 106 within an organization or department, all client devices 106 of a particular type, etc.).

The management service 113 can also determine which policies are applicable to the enrolled or registered client device 106 and create an appropriate configuration state 136 for the client device 106. For example, the management service 113 could evaluate any groups or roles that the client device 106 has been assigned to, and then select policies or configuration profiles applicable to the client device 106. Moreover, the management service 113 could evaluate any policy or profile assigned to the client device 106 specifically (e.g., because an administrator using the management console 116 assigned the policy or profile to the client device 106). As a result of the evaluation, the management service 113 could generate a configuration state 136 for the client device 106 and save the configuration state 136 to the appropriate device record 123.

The management service 113 can then distribute the configuration state 136 to the client device 106. For example, the management service 113 could save the configuration state 136 to the appropriate command queue 129 for the client device 106. In examples of this disclosure, the management service 113 could create and save a copy of the new configuration state 136 associated with the device identifier 133 of the device record 123 of the client device 106 to a new block in the blockchain in the configuration blockchain network 109. In some instances, the configuration state 136 itself could be saved, while in other instances, a zero-knowledge proof of the configuration state 136 could be saved to the block of the blockchain in the configuration blockchain network 109.

Meanwhile, the management agent 139 executing on the client device 106 can periodically retrieve configuration state 136 corresponding to the client device 106 from the configuration blockchain network 109. For example, the management agent 139 could use the blockchain client 143 to obtain the latest version of the configuration state 136 published to the configuration blockchain network 109 by the management service 113. The policies, profiles, and other data defining the configuration of the client device 106 that are included in the configuration state 136 can be stored onto the client device 106 for reference by the management agent 139. In another scenario, whenever an application on the client device 106 requests a data operation, such as filesystem capabilities, use of network capabilities, or data storage or retrieval capabilities of the client device 106, the management agent 139 can retrieve a configuration state 136 corresponding to the client device 106 from the configuration blockchain network 109 and determine whether the requested operation is permitted by the configuration state 136. Similarly, whenever the client device 106 attempts to execute an application or container containing one or more applications, the management agent 139 can retrieve a configuration state 136 corresponding to the client device 106 from the configuration blockchain network 109 and determine whether the application or containers being executed on the client device 106 are permitted by the configuration state 136. The management agent 139 could then apply the configuration state 136 to the client device 106. In some implementations, the management agent 139 could then publish to the configuration blockchain network 109 an acknowledgement of its current configuration state 136 as proof that the client device 106 is currently in a compliant state consistent with the configuration specified by the management service 113.

The management service 113 can also distribute a key pair or an encryption key that the client device 106 can utilize to sign or encrypt metadata 177 or other information that is published to the data attribute blockchain network 111. By utilizing a configuration state 136 that is enforced by the management agent 139 and signing data published to the data attribute blockchain network 111 with a key issued to the client device 106 by the management service 113, consumers of a data record 173 can trust the metadata 177 that is published.

Referring next to FIG. 2, shown is a sequence diagram that provides one example of the interactions between the management agent 139, a configuration smart contract 156, and an aggregation smart contract 165. The sequence diagram of FIG. 3 provides merely an example of the many different types of functional arrangements that can be employed to implement the operations of the depicted portions of the management agent 139, a configuration smart contract 156, and an aggregation smart contract 165. As an alternative, the sequence diagram of FIG. 2 can be viewed as depicting an example of elements of a method implemented within the network environment 100.

Beginning with block 234, the management agent 139 running on a client device 106 can detect an event occurring on the client device 106 that generates data that should be reported to the data attribute blockchain network 111. The data generated by the event can be an output of an operation performed by a client application 146. For example, the output could be a database query result, a transaction output based upon an input provided to the client application 146, or any other output that can be generated by an application in response to an input. The data generated by the application can be provided to a consumer, which can comprise another application, system, or entity. The data attribute blockchain network 111 can be a public or permissioned blockchain that can be accessed by third parties.

At block 237, the management agent 139 could generate a state ZKP 163 and submit it to the configuration smart contract 156 to store on the blockchain 153 to prove that the current state of the client device 106 complies with the current configuration state 136 assigned by the management service 113 without explicitly disclosing the current configuration of the client device 106. The management service 113 or other applications (e.g., such as those run by auditors) could evaluate the state ZKP 163 to confirm that state the client device 106 matches the configuration state 136 specified for the client device 106. Examples of ZKPs that could be used for the state ZKP 163 can include non-interactive zero knowledge (NIZK) proofs, zero-knowledge succinct non-interactive argument of knowledge (zk-SNARK) proofs, and zero-knowledge scalable transparent argument of knowledge (zk-STARK) proofs.

At block 240, the management agent 139 can obtain data related to the event occurring on the client device 106 that should be reported to the data attribute blockchain network 111. In one implementation, a client application 146 running on the client device 106 can be instrumented to generate a data output that is provided to the management agent 139. In another implementation, the client application 146 can directly report event data to the data attribute blockchain network 111 for publication. The client application 146 or the management agent 139 can also generate a data profile corresponding to the data according to a data classification model. The data profile can identify a data type, such as whether the data is personally identifiable information, medical information, publicly available information, confidential information, etc. The data profile can also identify an owner of the data generated by the client application 146. The data profile can specify a data format or schema of the data generated by the client application 146. The data profile can further identify geolocation data that can be attributed to or associated with the data generated by the client application 146.

The client application 146 can further generate a hash of the data. The hash of the data can enable a third party to validate the data provided by the client application 146 or management agent 139 to the data consumer. The hash could be signed or encrypted using a key issued to the client device 106 by the management service 113. In some implementations, the data generated by the client application 146 can be divided into logical objects or chunks that can be transferred using an encrypted wrapper or shield and decrypted at its destination using the metadata 177 that is published to the data attribute blockchain network 111.

At block 243, the management agent 139 can publish metadata 177 to the data attribute blockchain network 111 by providing the data obtained on the client device 106 to a data smart contract 171 running on the data attribute blockchain network 111. For example, the data smart contract 171 could maintain data records 173, which could be stored on the blockchain and generated at block 246. Because the data attribute blockchain network 111 may be publicly accessible, a data record 173 can be publicly accessible. Accordingly, a data record 173 could include a device identifier 175 for a specific client device 106 and metadata 177 that represents the data generated on the client device 106. The event can relate an application executing on the client device 106, such as the output of an operation or application running on the client device 106. At block 249, the data smart contract 171 can store the data record 173 on the blockchain for access by third parties.

In some cases, the data record 173 can comprise a ZKP that includes a representation of the usage data without including certain sensitive information from the client device 106 or the application itself. Other applications (e.g., such as those run by auditors) could evaluate the data record 173 to evaluate or validate data obtained from the client application 146. Examples of ZKPs that could be used for the aggregation data 169 can include non-interactive zero knowledge (NIZK) proofs, zero-knowledge succinct non-interactive argument of knowledge (zk-SNARK) proofs, and zero-knowledge scalable transparent argument of knowledge (zk-STARK) proofs. The aggregation data can be stored along with a device identifier 175 for a client device 106 or a user identifier corresponding to a user of the application running on the client device 106.

A number of software components previously discussed are stored in the memory of the respective computing devices and are executable by the processor of the respective computing devices. In this respect, the term “executable” means a program file that is in a form that can ultimately be run by the processor. Examples of executable programs can be a compiled program that can be translated into machine code in a format that can be loaded into a random access portion of the memory and run by the processor, source code that can be expressed in proper format such as object code that is capable of being loaded into a random access portion of the memory and executed by the processor, or source code that can be interpreted by another executable program to generate instructions in a random access portion of the memory to be executed by the processor. An executable program can be stored in any portion or component of the memory, including random access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory includes both volatile and nonvolatile memory and data storage components. Volatile components are those that do not retain data values upon loss of power. Nonvolatile components are those that retain data upon a loss of power. Thus, the memory can include random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random access memory (SRAM), dynamic random access memory (DRAM), or magnetic random access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The sequence diagrams show the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although the sequence diagrams show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the sequence diagrams can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g, storage area networks or distributed or clustered filesystems or databases) may also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random access memory (RAM) including static random access memory (SRAM) and dynamic random access memory (DRAM), or magnetic random access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same computing environment.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

Therefore, the following is claimed:

1. A system, comprising:
a computing device comprising a processor and a memory; and
machine-readable instructions stored in the memory that, when executed by the processor, cause the computing device to at least:
send a request to a smart contract hosted by a first blockchain network for a configuration state for the computing device, the request comprising a device identifier for the computing device;
receive the configuration state from the smart contract;
apply the configuration state to the computing device;
identify an event related to an application executed by the computing device;
identify data generated by the event, wherein the data is accessible to the computing device;
identify a data smart contract hosted by a second blockchain network that is specified by the configuration state, the data smart contract configured to store metadata corresponding to data generated by the event to the second blockchain network; and
provide metadata corresponding to the data generated by the event to the data smart contract, wherein the data smart contract writes the metadata to the second blockchain network.

2. The system of claim 1, wherein the machine-readable instructions further cause the computing device to at least:
profile the data generated by the event according to a data classification;
generate a hash of the data generated by the event;
provide the profile and the hash of the data to the data smart contract; and
cause the data smart contract to publish the profile and the hash to the second blockchain network.

3. The system of claim 2, wherein the data classification specifies at least one of a data type, a data owner, a data format, a data licensing arrangement, or a location attribute associated with the data.

4. The system of claim 1, wherein the second blockchain network comprises a public ledger that is accessible to third parties.

5. The system of claim 1, wherein the second blockchain network comprises an audit smart contract that generates an audit result of the data related to the event and the computing device.

6. The system of claim 1, wherein the machine-readable instructions further cause the computing device to at least generate a rollup of the data generated by the event, wherein the data smart contract writes the rollup of the data generated by the event to the second blockchain network.

7. The system of claim 1, wherein the hash of the data is signed by a key specified by the configuration state applied to the computing device.

8. A method, comprising:
sending a request to a smart contract hosted by a first blockchain network for a configuration state for the computing device, the request comprising a device identifier for the computing device;
receiving the configuration state from the smart contract;
applying the configuration state to the computing device;
identifying an event related to an application executed by the computing device;
identifying data generated by the event, wherein the data is accessible to the computing device;
identifying a data smart contract hosted by a second blockchain network that is specified by the configuration state, the data smart contract configured to store metadata corresponding to data generated by the event to the second blockchain network; and
providing metadata corresponding to the data generated by the event to the data smart contract, wherein the data smart contract writes the metadata to the second blockchain network.

9. The method of claim 8, further comprising:
profiling the data generated by the event according to a data classification;
generating a hash of the data generated by the event;
providing the profile and the hash of the data to the data smart contract; and
causing the data smart contract to publish the profile and the hash to the second blockchain network.

10. The method of claim 9, wherein the data classification specifies at least one of a data type, a data owner, a data format, a data licensing arrangement, or a location attribute associated with the data.

11. The method of claim 8, wherein the second blockchain network comprises a public ledger that is accessible to third parties.

12. The method of claim 8, wherein the second blockchain network comprises an audit smart contract that generates an audit result of the data related to the event and the computing device.

13. The method of claim 8, further comprising generating a rollup of the data generated by the event, wherein the data smart contract writes the rollup of the data generated by the event to the second blockchain network.

14. The method of claim 8, wherein the hash of the data is signed by a key specified by the configuration state applied to the computing device.

15. A non-transitory, computer-readable medium, comprising machine-readable instructions that, when executed by a processor of a computing device, cause the computing device to at least:
send a request to a smart contract hosted by a first blockchain network for a configuration state for the computing device, the request comprising a device identifier for the computing device;
receive the configuration state from the smart contract;
apply the configuration state to the computing device;
identify an event related to an application executed by the computing device;
identify data generated by the event, wherein the data is accessible to the computing device;
identify a data smart contract hosted by a second blockchain network that is specified by the configuration state, the data smart contract configured to store metadata corresponding to data generated by the event to the second blockchain network; and
provide metadata corresponding to the data generated by the event to the data smart contract, wherein the data smart contract writes the metadata to the second blockchain network.

16. The non-transitory, computer-readable medium of claim 15, wherein the machine-readable instructions further cause the computing device to at least:
profile the data generated by the event according to a data classification;
generate a hash of the data generated by the event;
provide the profile and the hash of the data to the data smart contract; and
cause the data smart contract to publish the profile and the hash to the second blockchain network.

17. The non-transitory, computer-readable medium of claim 16, wherein the data classification specifies at least one of a data type, a data owner, a data format, a data licensing arrangement, or a location attribute associated with the data.

18. The non-transitory, computer-readable medium of claim 15, wherein the second blockchain network comprises an audit smart contract that generates an audit result of the data related to the event and the computing device.

19. The non-transitory, computer-readable medium of claim 15, wherein the machine-readable instructions further cause the computing device to at least generate a rollup of the data generated by the event, wherein the data smart contract writes the rollup of the data generated by the event to the second blockchain network.

20. The non-transitory, computer-readable medium of claim 15, wherein the hash of the data is signed by a key specified by the configuration state applied to the computing device.
